(19) United States
(12) Patent Application Publication
(10) Pub. No.: US 2018/0183795 A1
(43) Pub. Date: Jun. 28, 2018

(54) PROVIDING AUTHENTICATION INFORMATION FROM AN ONLINE SYSTEM TO A CLIENT DEVICE TO ALLOW THE CLIENT DEVICE TO EXECUTE AN APPLICATION ASSOCIATED WITH THE ONLINE SYSTEM

(71) Applicant: VenueNext, Inc., Santa Clara, CA (US)

(72) Inventor: William Malizia, Philadelphia, PA (US)

(21) Appl. No.: 15/389,137

(22) Filed: Dec. 22, 2016

(51) Int. Cl. H04L 29/06; H04W 4/00; H04W 12/06; H04W 4/14; H04L 29/08

(52) U.S. Cl. CPC H04L 63/10; H04W 4/001; H04W 12/06; H04L 63/18; H04L 67/146; H04L 63/083; H04W 4/14

(57) ABSTRACT

A client device including an application associated with an online system transmits information identifying the client device to the online system when the application is launched. For example, the client device communicates a phone number of the client device to the online system. If the online system determines the client device is authorized to execute the application from the information identifying the client device, the online system transmits authentication information to the client device to provide to the application. When the application receives the authentication information, the application executes, allowing a user of the client device to execute the application without remembering authentication information for the application.

### BACKGROUND

This invention relates generally to content provided by an online system, and more specifically to regulating execution of an application associated with an online system on client devices.

Various online systems allow users to access or to modify information maintained by an online system by providing applications to client devices. By interacting with an application associated with the online system that executes on a client device, a user may access information maintained by the online system or may provide information to the online system. However, online systems often limit execution of the application to users for whom the online system maintains information. For example, users who do not have a user profile maintained on the online system are unable to execute the application on a client device.

Conventional online systems limit execution of an application associated with an online system and executing on a client device by having a user provide authentication information to the application. The authentication information is communicated from the client device to the online system, which determines if the authentication information corresponds to a user authorized to execute the application on the client device. An online system may specify that authentication information for a user satisfies various criteria to prevent unauthorized users from replicating authentication information and executing the application via a client device. However, having users provide authentication information to execute the application associated with the online system makes it more complex for the users to execute the application by having the users remember and provide authentication information to the application to execute the application. Additionally, if authentication information is subject to one or more criteria, having users determine authentication information satisfying the criteria increases complexity of users determining the authentication information, which may make users less likely to use the application to access information from the online system.

### SUMMARY

An online system allows users to access content maintained by the online system. For example, users of the online system provide content to the online system to be maintained, modify content maintained by the online system, or interact with content maintained by the online system. To allow users to access content, the online system provides an application associated with the online system to various client devices. When a client device executes the application, the user may access information maintained by the online system or provide information to the online system by interacting with the application via the client device.

The online system may regulate access to information maintained by online system to users having user profiles maintained by the online system or having user profiles maintained by the online system that include one or more specific values (e.g., a specific employer identifier, a specific role within an organization, etc.). In various embodiments, the online system limits execution of the application to client devices associated with users authorized by the online system to access information maintained by the online system. To regulate execution of the application by client devices, the online system maintains information identifying client devices authorized to execute the application such as client devices associated with users authorized to access information maintained by the online system. For example, the online system includes information identifying a client device associated with a user in a user profile maintained by the online system for the user. As another example, the online system stores a table associating a user profile identifier with information identifying a client device associated with a user profile corresponding to the user profile identifier. The online system may maintain any suitable information identifying client devices authorized to execute the application. For example, the online system maintains phone numbers of client devices authorized to execute the application. Alternatively, the online system maintains device identifiers (e.g., unique device ID numbers, international mobile station equipment identity numbers, equipment serial numbers, mobile equipment identifiers, mobile serial numbers, etc.) of client devices authorized to execute the application.

When a client device on which the application associated with the online system launches the application, the client device transmits information identifying the client device to the online system. For example, the application obtains a phone number of the client device and transmits the phone number to the online system when the application is launched (i.e., when the application is executed on the client device) on the client device. As another example, when the application is launched on the client device, the application obtains a device identifier stored by the client device and transmits the device identifier to the online system.

The online system compares the received information identifying the client device received from the client device with maintained information identifying client devices authorized to execute the application. For example, the online system compares a phone number identifying the client device to phone numbers included in user profiles maintained by the online system. As another example, the online system compares a device identifier received from the client device to a table including device identifiers of client devices authorized to execute the application.

Based on the comparison, the online system determines whether the client device is authorized to execute the application. If the comparison indicates that information identifying the client device matches information maintained by the online system identifying client devices authorized to execute the application, the online system determines the client device is authorized to execute the application. For example, if a phone number identifying the client device matches a phone number included in a list of phone numbers authorized to execute the application maintained by the online system, the online system determines the client device is authorized to execute the client device. In response to determining the client device is authorized to execute the application, the online system obtains authentication information for the client device to execute the application. The online system generates the authentication information in response to determining the client device is authorized to execute the application in some embodiments.

In some embodiments, the authentication information specifies actions the user associated with the client device is authorized to perform via the application. For example, after determining the client device is authorized to execute the application, the online system identifies a user profile associated with the client device and determines actions that a user corresponding to the user profile is authorized to perform via the application. The online system may authorize different users to perform different actions via the application based on one or more characteristics of user profiles corresponding to the different users. For example, the online system determines a set of actions that a user is authorized to perform via the application based on an employer and a job title included in a user profile maintained by the online system for the user. In other embodiments, the online system determines actions that a user is authorized to perform via the application based on suitable characteristic included in a user profile maintained by the online system for the user.

The online system transmits the authentication information to the client device. In various embodiments, the online system transmits the authentication information using a different communication channel than a communication channel from which the online system received the information identifying the client device from the client device. For example, the online system receives information identifying the client device via an Internet Protocol (IP) network and transmits the authentication information via a cellular network. In some embodiments, the online system transmits a text message including the authentication information to the client device.

When the client device receives the authentication information from the online system, the authentication information is provided to the application via the client device. For example, the client device presents the authentication information to a user, who enters the authentication information into the application. As another example, the application associated with the online system receives the authentication information from the online system. When the authentication information is provided to the application, the client device executes the application, allowing a user of the client device to access content maintained by the online system via the application.

Obtaining the authentication information in response to receiving information identifying the client device allows the online system to regulate execution of the application, and also allows the online system to more easily enforce criteria for the authentication information. For example, rather than provide a user authorized to execute the application with a set of criteria for the authentication information and have the user generate authentication information satisfying the criteria, the online system generates authentication information satisfying the criteria and provides the authentication information to a client device associated with the user to execute the application. Additionally, because the online system provides the criteria to a client device, the user need not commit authentication information to memory, which may encourage use of the application by allowing the user to more easily execute the application on a client device.

### BRIEF DESCRIPTION OF THE DRAWINGS

FIG. 1 is a block diagram of a venue, in accordance with an embodiment of the invention.

FIG. 2 is a block diagram of a system environment including an online system, in accordance with an embodiment.

FIG. 3 is a block diagram of an online system, in accordance with an embodiment.

FIG. 4 is an interaction diagram of a method for providing authentication information from an online system to a client device to execute an application associated with the online system, in accordance with an embodiment.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION

### Venue Overview

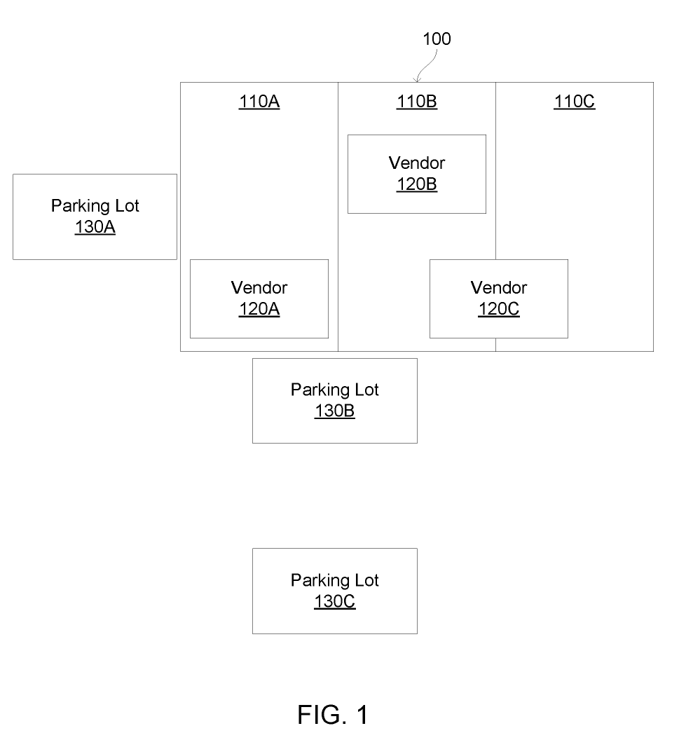

FIG. 1 is a block diagram of one embodiment of a venue 100. In the example of FIG. 1, the venue includes multiple regions 110A, 110B, 110C (also referred to individually and collectively using reference number 110). Additionally, one or more vendors 120A, 120B, 120C (also referred to individually and collectively using reference number 120) are included in the venue 100, and one or more parking lots 130A, 130B, 130C (also referred to individually and collectively using reference number 130) are associated with the venue 100. However, in other embodiments, different and/or additional components may be associated with or included in the venue 100.

The venue 100 is a geographic location, such as a geographic location associated with one or more structures. Examples of a venue 100 include a stadium, a convention center, an arena, a theater, an amphitheater, or other suitable structure. One or more regions 110 are included in the venue 100, with each region 110 corresponding to an area within the venue 100. For example, different regions 110 correspond to different sections of a stadium, different aisles of a stadium or arena, different rooms in a convention center, or any other suitable area within the venue 100. In some embodiments, an area within the venue 100 is associated with multiple regions 110 having different levels of precision. For example, a specific seat in a venue 100 is associated with a region 110 identifying a section including the seat, another region 110 identifying an aisle within the section including the seat, and an additional region identifying the specific seat. While FIG. 1 shows an example venue 100 including three regions 110A, 110B, 110C, in other embodiments, a venue 110 may include any number of regions 110.

One or more vendors 120 are included in the venue 110, with each vendor providing products or services to users within the venue 110. Examples of vendors 120 include restaurants, food service providers, beverage providers, merchandise retailers, or other suitable entities providing products or services. Different vendors 120 may be associated with different regions 110 of the venue. For example, a vendor 120A is associated with a region 110A, while a different vendor 120B is associated with a different region 110B. A vendor 110 may be associated with multiple regions 110; for example, a vendor 110C is associated with a region 110B as well as with an additional region 110C. In some embodiments, a vendor 120 is associated with a region 110 based on a distance between the vendor 120 and the region 110. For example, the vendor 120 is associated with a region 110 having a minimum distance from a location associated with the vendor 120. If a location associated with a vendor 120 is within a region 110, the vendor 120 is associated with the region 110 including the vendor's associated location.

Additionally, one or more parking lots 130A, 130B, 130C are associated with the venue 110 and identify physical locations for parking vehicles. Each parking lot includes one or more spaces, each space for parking a vehicle. A price is associated with each parking lot 130 specifying an amount of compensation a user provides to an entity associated with the venue 110 for a space in the parking lot 130 to be allocated for parking a vehicle associated with the user. Different parking lots 130 may have different distances from the venue 110, and prices associated with different parking lots 130 may be inversely proportional to a distance between a parking lot 130 and the venue 110. Each parking lot 130 is also associated with a capacity specifying a maximum number of vehicles that may be parked in a parking lot 130. The capacity may be total number of spaces in the parking lot 130 or may be a maximum number of vehicles. Information may be maintained by one or more devices included in a parking lot 130 specifying a number of spaces in the parking lot 130 in which vehicles are parked, specifying a number of vehicles within a geographic area associated with the parking lot 130, or any other suitable information. For example, a device included in the parking lot 130 increments a counter when a vehicle enters the geographic area associated with the parking lot 130 or when a vehicle is parked in a space of the parking lot 130.

### System Architecture

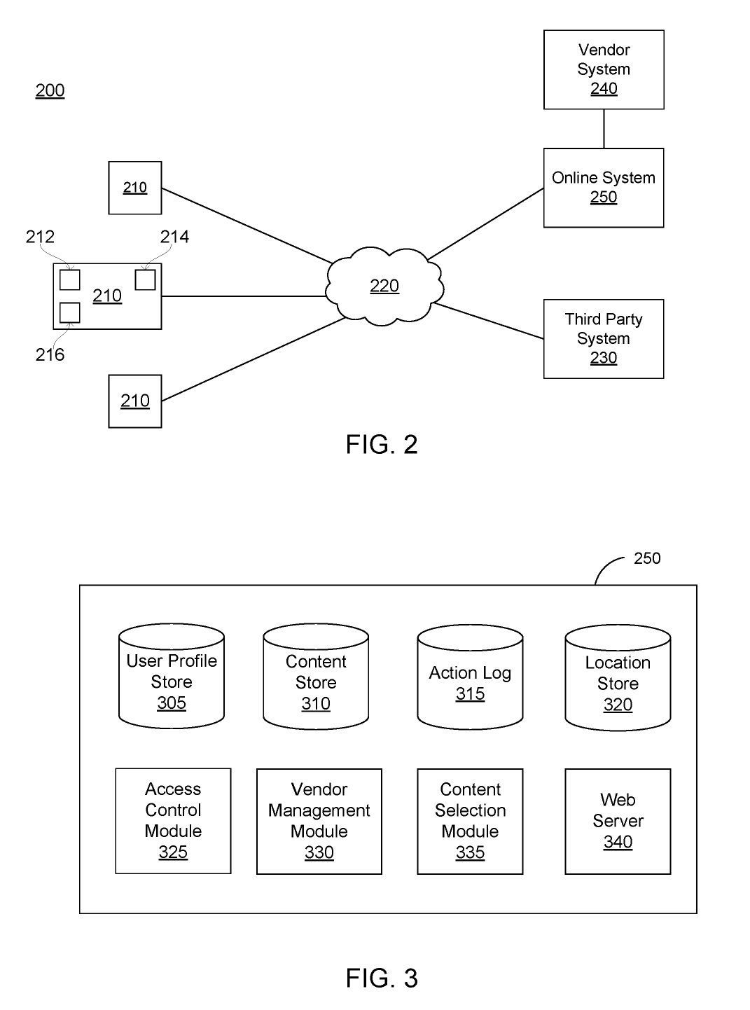

FIG. 2 is a block diagram of a system environment 200 for an online system 250. The system environment 200 shown by FIG. 1 includes various client devices 210, a network 220, a third party system 230, one or more vendor systems 240, and an online system 250. In alternative configurations, different and/or additional components may be included in the system environment 200. The embodiments described herein may be adapted to online systems other than venue management systems.

A client device 210 is one or more computing devices capable of receiving user input as well as transmitting and/or receiving data via the network 220. In one embodiment, the client device 210 is a conventional computer system, such as a desktop computer or a laptop computer. Alternatively, the client device 210 may be a device having computer functionality, such as a personal digital assistant (PDA), a mobile telephone, a smartphone or another suitable device. A client device 210 is configured to communicate with other devices via the network 220. In one embodiment, the client device 210 executes an application allowing a user of the client device 210 to interact with the online system 250. For example, the client device 210 executes a browser application to enable interaction with the online system 250 or with one or more third party system 230 via the network 220. In another embodiment, a client device 210 interacts with the online system 250 through an application programming interface (API) running on a native operating system of the client device 210, such as IOS® or ANDROID™.

A display device 212 included in a client device 210 presents content items to a user of the client device 210. Examples of the display device 212 include a liquid crystal display (LCD), an organic light emitting diode (OLED) display, an active matrix liquid crystal display (AMLCD), or any other suitable device. Different client devices 210 may have display devices 212 with different characteristics. For example, different client devices 212 have display devices 212 with different display areas, different resolutions, or differences in other characteristics.

One or more input devices 214 included in a client device 210 receive input from the user. Different input devices 214 may be included in the client device 210. For example, the client device 210 includes a touch-sensitive display for receiving input data, commands, or information from a user. Using a touch-sensitive display allows the client device 210 to combine the display device 212 and an input device 214, simplifying user interaction with presented content items. In other embodiments, the client device 210 may include a keyboard, a trackpad, a mouse, or any other device capable of receiving input from a user. Additionally, the client device may include multiple input devices 214 in some embodiments. Inputs received via the input device 214 may be processed by an application associated with the online system 250 and executing on the client device 210 to allow a client device user to exchange information with the online system 250.

Additionally, a client device 210 may include one or more position sensors 216, which determine a physical location associated with the client device 210. For example, a position sensor 216 is a global positioning system (GPS) sensor that determines a location associated with the client device 210 based on information obtained from GPS satellites communicating with the GPS sensor, such as coordinates specifying a latitude and longitude of the location associated with the client device 210. As another example, a position sensor 216 determines a location associated with the client device 210 based on intensities of signals received from one or more access points (e.g., wireless access points) by the client device 110. In the preceding example, the position sensor 216 determines a location associated with the client device 210 based on signal intensity between the client device 210 and one or more wireless access points and service set identifiers (SSIDs) or media access control (MAC) addresses of the wireless access points. However, the client device 210 may include any suitable type of position sensor 216. In various embodiments, the client device 210 may include multiple position sensors 216.

The network 220 may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

One or more third party systems 130 may be coupled to the network 220 for communicating with one or more client devices 110 or with the online system 250. In one embodiment, a third party system 230 is an application provider communicating information describing applications for execution by a client device 210 or communicating data to client devices 110 for use by an application executing on the client device 210. In other embodiments, a third party system 230 provides content or other information for presentation via a client device 210. For example, a third party system 230 provides content related to an event occurring at the venue 110 to a client device 210 for presentation to a user; as an example, the third party system 230 provides video or audio data of a portion of an event occurring at the venue to a client device 210, allowing a user associated with the client device 210 to view the portion of the event from an alternative vantage point than the user's vantage point or to hear commentary about the portion of the event. As another example, a third party system 230 is a social networking system maintaining connections between various users and providing content for presentation to users based at least in part on the maintained connections. A third party system 230 may also communicate information to the online system 250, which subsequently communicates the information, or a portion of the information, to one or more client devices 110 via the network 220.

Additionally, one or more vendor systems 240 are coupled to the online system 250 via the network 220 or through direct connections between the vendor systems 240 and the vendor management system 150. A vendor system 240 is associated with a vendor 120 and receives orders for products or services from the online system 250 and provides the products or services identified by the orders. Further, a vendor system 240 provides the online system 250 with information describing fulfillment of orders by a vendor 120 associated with the vendor system 240. For example, the vendor system 240 provides information to the online system 250 specifying an estimated time to fulfill subsequently received or pending orders for products or services, an average time in which previously received orders were fulfilled, a number of unfulfilled orders received by the vendor system 240, or other suitable information. Information provided from the vendor system 240 to the vendor management system 150 accounts for orders received via the vendor management system 150 as well as orders received by the vendor 120 associated with the vendor system 240 from users visiting a location associated with the vendor 120.

Additionally, a vendor system 240 may provide information to the online system 250 describing products or services sold by a vendor 120 associated with the vendor system 240. For example, the vendor system 240 identifies a number of different products or services sold by the vendor 120 or identifies an amount of revenue received by the vendor 120 in exchange for different products or services. Information describing sold products or services may be communicated from the vendor system 240 to the online system 250 as the products or services are sold or may be communicated from the vendor system to the online system 250 at periodic intervals. Additionally, the online system 250 may request information describing sales of products or services to a vendor system 240, which provides the requested information to the online system 250 in response to receiving the request.

The online system 250, which is further described below in conjunction with FIG. 3, receives content from one or more third party systems 230 or generates content and provides content to users via an application associated with the online system 250 and executing on client devices 210. Additionally, the online system 250 maintains information associated with one or more parking lots 130 associated with a venue 100, such as a number of spaces in a parking lot 130 currently occupied, a price associated with a the parking lot 130, or a number of spaces in the parking lot 130 that have been purchased, as well as directions for navigating to a location associated with the parking lot 130. The online system 250 may communicate certain information associated with a parking lot 130 to one or more users, such as the price associated with the parking lot 130 or directions to the location associated with the parking lot 130. Associations between one or more vendors 120 and regions 110 of the venue 100 are also included in the online system 250, which also receives orders for products or services from one or more users and communicates the orders to one or more vendors 120 for fulfillment.

FIG. 3 is a block diagram of an architecture of an online system 250. The online system 250 shown in FIG. 3 includes a user profile store 305, a content store 310, an action log 315, a location store 320, an access control module 325, a vendor management module 330, a content selection module 335, and a web server 340. In other embodiments, the social networking system 130 may include additional, fewer, or different components for various applications. Conventional components such as network interfaces, security functions, load balancers, failover servers, management and network operations consoles, and the like are not shown so as to not obscure the details of the system architecture. In other embodiments, the online system 250 is any system providing content to users.

Each user of the online system 250 is associated with a user profile, which is stored in the user profile store 305. A user profile includes declarative information about the user provided by the user and may also include information inferred by the online system 250 from actions associated with the user or from other information. In one embodiment, a user profile includes multiple data fields, each describing one or more attributes of the corresponding user. Examples of information stored in a user profile include demographic information, contact information, preferences, and location information. For example, a user profile identifies a region 110 of the venue 100 associated with a user, such as a region 110 including a seat associated with a ticket to attend the venue 100 associated with the user. A user profile may also store other information provided by the user, for example, image data or video data. Additionally, a user profile in the user profile store 205 may also maintain references to actions by the corresponding user performed on content presented by the online system 250 or interactions between the corresponding user captured by one or more vendor systems 240 and communicated to the online system 250. For example, a user profile identifies prior orders for products or services the online system 250 received from a user and communicated to one or more vendor systems 150.

In some embodiments, a user profile includes a status associated with the user. The online system 250 may provide different functionality to a user based on the user's status. For example, the online system 250 communicates certain types of messages to client devices 210 associated with users having a specific type of status and does not communicate the certain types of messages to client devices 210 associated with users that do not have the specific type of status. As another example, the online system 250 presents less advertisement content to users having specific statuses. The status may be based on a frequency with which the user is associated with tickets to attend the venue 100 or an amount of money the online system 250 has received from the user (e.g., based on an amount the user has spent on tickets to attend the venue 100). Additionally, a user may provide an amount of compensation to the online system 250 for a specific status to be associated with the user. For example, the user provides the online system 250 with an amount of compensation per year or per month for the online system 250 to associate a specific status with the user.

The content store 310 stores objects that each represents various types of content received from one or more third party systems 230 or generated by the online system 250. Examples of content represented by an object include video data associated with an event occurring at the venue 100, image data associated with an event occurring at the venue 100, audio data associated with an event occurring at the venue 100, text data associated with an event occurring at the venue 100, information associated with the venue 100 or with the location of the venue 100, or other suitable. Additionally, content may be received from applications associated with a third party system 230 and executing on client devices 210 associated with users of the venue management system 230. In one embodiment, objects in the content store 210 represent single pieces of content, or content “items.”

The action log 315 stores information describing actions performed by venue management system users internal to or external to the online system 250. For example, actions performed by a user on a third party system 230 that communicates information to the online system 250 are stored in the action log 315 along with information describing actions performed by the user through the online system 250. Examples of actions include: ordering a product or service from a vendor 120 included in the venue 100, checking-into the venue, accessing content provided by the online system 250 or provided by a third party system 230 that communicates with the online system 250, providing a review of a product, service, or vendor 120 to the online system 250 or to a third party system 230 that communicates with the vendor management system 250, providing a comment associated with the venue 100 or with an event occurring at the venue 100 to the online system 250 or to a third party system 230 that communicates with the online system 250. However, any suitable action may be stored in the action log 315 and associated with a user profile in the user profile store 305. Information in the action log 315 may identify the user performing an action, a type of the action, a description of the action, a time associated with the action, or any other suitable information. In some embodiments, data from the action log 315 is used to infer interests or preferences of a user, augmenting interests included in the user's user profile and allowing a more complete understanding of user preferences.

The action log 315 may also store user actions taken on a third party system 230, such as an external website, and communicated to the online system 250. For example, an e-commerce website may recognize a user of the online system 250 through a plug-in enabling the e-commerce website to identify the venue management system user. Because users of the online system 250 are uniquely identifiable, third party systems 230 may communicate information about a user's actions outside of the online system 250 to the online system 250 for association with the user. Hence, the action log 315 may record information about actions users perform on a third party system 230, such as purchases made, comments on content, or other information a user authorizes a third party system 230 to communicate to the vendor management system 250.

The location store 320 includes physical locations associated with various regions 110 of the venue 100. In various embodiments, the location store 320 includes a region identifier associated with each region 110 and information identifying a geographic area associated with the region identifier. Any suitable information may identify the geographic area associated with a region identifier. Example information identifying a geographic area of a region 110 include: physical coordinates specifying boundaries of a region 110 and an identifier of a portion of the venue 100 including the region 110. Additionally, the location store 320 includes data associating vendors 120 with one or more regions 110 of the venue 100. A vendor identifier uniquely associated with a vendor 120 is associated with a region identifier, with the association stored in the location store 320. Multiple vendors 120 may be associated with a region 110 of the venue 100.

In some embodiments, the location store 320 also associates location information with users of the online system 250. A client device 210 communicates location information to the online system 250, which may store the location information in the location store 320 or in the user profile store 305 in association with the user. Based on the received information, the online system 250 may determine a region 110 of the venue including the location information and associate the region identifier of the determined region with a user profile corresponding to the user. If the online system 250 receives modified location information from the client device 210, the venue management system 205 may modify the determined region 110 if a different region includes the modified location information. Alternatively, one or more sensors included in the venue 100 identify a client device 210 and determine a location associated with the client device 210. Based on the determined location, the online system 250 identifies a region 110 including the client device 110 and stores a region identifier of the region 110 in association with a user identifier of a user associated with the client device 210. In various embodiments, information identifying a location associated with the client device 210 (e.g., latitude and longitude) is also stored in the location store 320 in association with an identifier associated with the user associated with the client device 210. Additionally, the online system 250 may assign a location to a user and store the assigned location in association with the user in the location store 320. For example, when a user purchases a ticket to enter the venue 100, the ticket is associated with a location assigned to the user, and the location store 320 includes information associating the location assigned to the user from the ticket with an identifier associated with the user.

The access control module 325 maintains information regulating access to content maintained by the online system 250. In various embodiments, the online system 250 includes information identifying client devices 210 authorized to execute an application associated with the online system 250. The application allows a user to access information maintained by the online system 250, modify information maintained by the online system 250, or store information via the online system 250 by interacting with a client device 210 executing the application. For example, the access control module 325 includes information identifying a client device 210 associated with a user having a user profile included in the user profile store 305 or identifying a client device 210 associated with a user having a user profile included in the user profile store 350 having one or more specific characteristics (e.g., a particular employer, a particular job title). As another example, the access control module 325 stores a table associating a user profile identifier with information identifying a client device 210 associated with a user profile corresponding to the user profile identifier. Any suitable information may be used to identify client devices 210 authorized to execute the application. For example, the access control module 325 maintains phone numbers of client devices 210 authorized to execute the application. Alternatively, the access control module 325 maintains device identifiers (e.g., unique device ID numbers, international mobile station equipment identity numbers, equipment serial numbers, mobile equipment identifiers, mobile serial numbers, etc.) of client devices 210 authorized to execute the application.

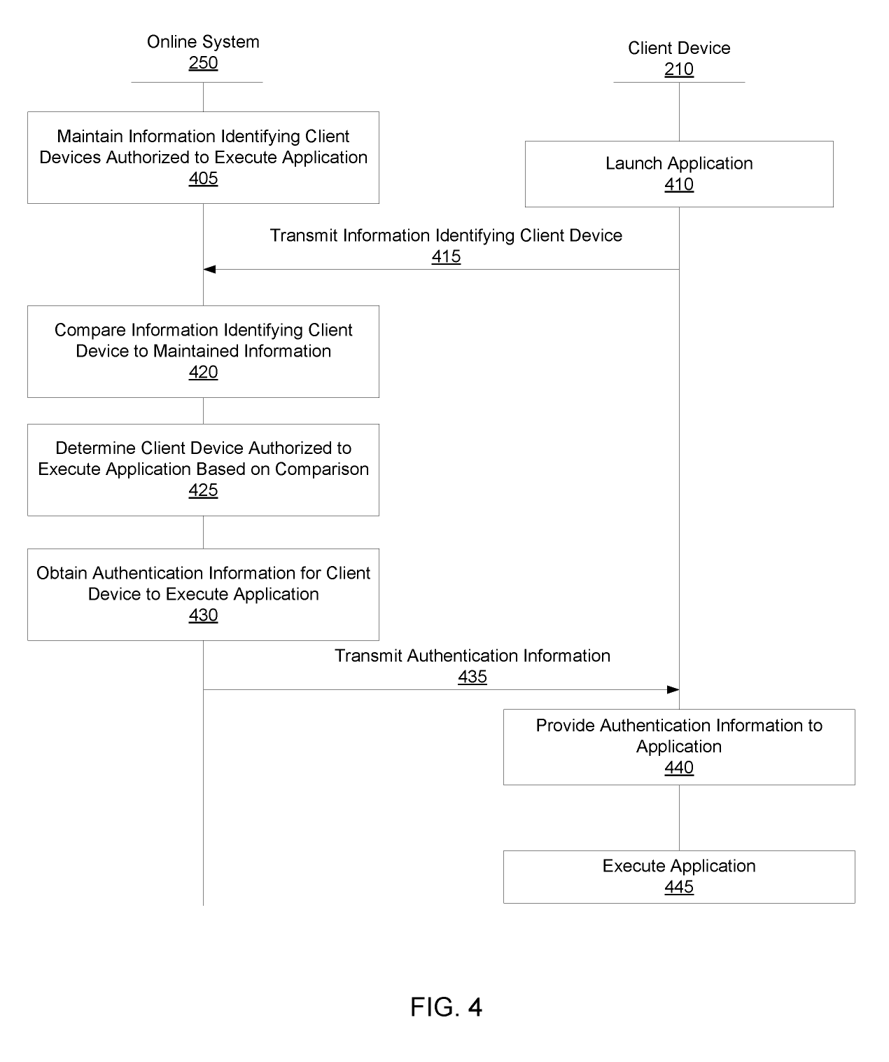

To regulate execution of the application by client devices 210, the access control module 325 receives information identifying a client device 210 when the client device 210 launches the application. As further described below in conjunction with FIG. 4, the access control module 325 determines whether the client device 210 is authorized to execute the application by comparing the information identifying the client device 210 to information included in the access control module 325 identifying client devices 210 authorized to execute the application. If the information identifying the client device 210 matches information in the access control module 325 identifying a client device 210 authorized to execute the application, the access control module 325 obtains authentication information for the application and transmits the authentication information to the client device 210, allowing execution of the application by the client device 210. For example, the access control module 325 generates a password satisfying one or more criteria if the information identifying the client device 210 matches information in the access control module 325 identifying a client device 210 authorized to execute the application. The generated password is transmitted to the client device 210, allowing the application to be executed on the client device 210 when the application receives the generated password. This allows the access control module 325 to limit execution of the application by client devices 210 without having users associated with client devices 210 authorized to execute the application remember and provide authentication information to the application upon launching the application. Generation and transmission of authentication information is further described below in conjunction with FIG. 4.

The vendor management module 330 receives orders for products or services from client devices 210 associated with users and communicates the orders to one or more vendor systems 240 of vendors 120 associated with the venue 100. In various embodiments, the vendor management module 330 includes vendor profiles each associated with one or more vendors 120 associated with the venue 100. A vendor profile includes a vendor identifier uniquely identifying a vendor 120 and additional information associated with the vendor 120, such as one or more regions 110 of the venue 100 associated with the vendor 120 and information for communicating with a vendor system 240 associated with the vendor 120. Further examples of information associated with the vendor 120 and included in a vendor profile include: contact information, hours of operation, a listing of products or services provided by the vendor 120, a current inventory or products maintained by the vendor 120, and a current time for the vendor 120 to fulfill received orders. However, in other embodiments, additional or different information may be included in the vendor profile. One or more users authorized by the online system 250 may communicate information to the vendor management system 330 to modify regions 110 of the venue associated with one or more vendors 120.

When the vendor management module 330 receives an order identifying a product or service and identifying a vendor 120 from a user, the vendor management system 330 communicates the order to a vendor system 240 corresponding to the identified vendor 120. The vendor 120 may subsequently deliver the product or service identified by the order to the user or may communicate a notification to the user via the online system 250 when the order is fulfilled. To expedite delivery of products or services, the vendor management module 330 may associate different vendors 120 with different regions 110 or the venue 100 to reduce time for users to receive products or services delivered by vendors 120. The vendor management module 330 may modify regions 110 of the venue 100 associated with a vendor 120 by modifying identifiers of regions 110 included in a vendor profile of a vendor 120. In some embodiments, the vendor management module 330 modifies regions 110 associated with a vendor 120 based on a number or a frequency of orders received from users associated with different regions 110 as well as time to fulfill orders by different vendors 120, products or services offered by different vendors 120, and number of orders received by different vendors 120. When modifying regions 110 associated with a vendor 120 or vendors 120 associated with a region, the venue management system 330 may account for products or services provided by various vendors 120 so similar products or services are provided to users in a region 110 before and after modification of the vendors 120 associated with the region 110.

Additionally, the vendor management module 330 receives information from a vendor system 240 and communicates the information to one or more client devices 210 for presentation to users. For example, the vendor 240 communicates a time to fulfill an order, an estimated time to fulfill an order, a number of previously received orders that have yet to be fulfilled, or other suitable information to the vendor management module 330, which provides at least a subset of the information to a client device 210 for presentation to a user. As another example, a vendor system 250 communicates a message to the venue management module 330 including a user identifier, an order identifier (or a description of an order), and an indication that an order corresponding to the order identifier has been fulfilled by a vendor. The vendor management module 330 identifies a user corresponding to the user identifier from the user profile store 305 and communicates the message to a client device 210 associated with the user.

As vendors 120 may deliver products to users in various regions 110 of the venue 100 to fulfill orders received from various users, in some embodiments, the vendor management module 330 regulates communication of orders received from client devices 210 associated with users to vendor systems 240 associated with various vendors 120. When the vendor management module 330 receives an order for a product or service from a client device 210 associated with a user, the vendor management module 330 stores the received order in a queue for a specified time interval before communicating the order to a vendor system 240 corresponding to a vendor 120 identified by the order. If the vendor management system 330 receives additional orders from users having one or more characteristics matching or similar to the order stored in the queue and identifying the vendor 120 identified by the order while the order is stored in the queue, the vendor management module 330 generates a group including the additional orders and the order stored in the queue and communicates the group or orders to a vendor system 240 associated with the vendor 120 to be fulfilled. For example, the vendor management system 330 generates a group including additional orders associated with users having a location matching a location of a user associated with an order stored in the queue. As additional examples, the vendor management system 330 generates a group including orders identifying products or services matching or similar to a product or service specified by an order stored in the queue or generates a group including orders identifying products or services having times for fulfillment within a threshold value of a time for fulfillment of the order stored in the queue. Communicating a group of orders having one or more matching or similar characteristics to a vendor system 240 allows the vendor 120 associated with vendor system 240 to more efficiently fulfill orders from users.

The content selection module 335 selects one or more content items for communication to a client device 210 for presentation to a user. Content items eligible for presentation to the user are retrieved from the content store 310, from a third party system 230, or from another source, by the content selection module 335, which selects one or more of the content items for presentation to the user. A content item eligible for presentation to the viewing user is a content item associated with at least a threshold number of targeting criteria satisfied by characteristics of the user or is a content item that is not associated with targeting criteria. For example, a content item associated with targeting criteria specifying a threshold distance of the venue 100 is identified as eligible for presentation to users associated with locations within a threshold distance of the venue 100. As another example, a content item associated with targeting criteria specifying attendance of an event at the venue 100 is identified as eligible for presentation to users attending the event or who have indicated they will attend the event. In various embodiments, the content selection module 335 includes content items eligible for presentation to the user in one or more selection processes, which identify a set of content items for presentation to the user. For example, the content selection module 335 determines a measure of relevance of various content items to a user based on characteristics associated with the user by the online system 250 based on actions associated with the user by the online system 250, characteristics of the user maintained by the online system 250, preferences of the user maintained by the online system 250, and characteristics of content items eligible for presentation to the user. For example, the content selection module 335 determines measures of relevance to a user based on characteristics of the content items, characteristics of the user, and actions associated with the user. Based on the measures of relevance, the content selection module 335 selects one or more content items for presentation to the user (e.g., content items having at least a threshold measure of relevance, content items having highest measures of relevance relative to other content items). In some embodiments, the content selection module 335 ranks content items based on their associated measures of relevance and selects content items having the highest positions in the ranking or having at least a threshold position in the ranking for presentation to the user.

A content item may be associated with bid amounts specifying an amount of compensation received by the online system 250 from a third party system 130 or from a user if one or more criteria associated with the content item are satisfied. For example, a bid amount associated with a content item specifies an amount of compensation received by the online system 250 when the content item is presented to a user or when a user presented with the content item performs a specified type of interaction with the content item. The content selection module 335 uses the bid amounts associated with various content items when selecting content for presentation to the user. In various embodiments, the content selection module 335 determines an expected value associated with various content items based on their bid amounts and selects content items associated with a maximum expected value or associated with at least a threshold expected value for presentation to the user. An expected value associated with a content item represents an expected amount of compensation to the online system 250 for presenting a content item. For example, the expected value associated with a content item is a product of the content item's bid amount and a likelihood of the user interacting with the content item. The content selection module 335 may rank content items associated with bid amounts separately than content items that are not associated with bid amounts and select content items for presentation based on the separate rankings (e.g., content items having at least a threshold position in a ranking)

The web server 340 links online system 250 via the network 220 to one or more client devices 210, as well as to one or more third party systems 230. Additionally, the web server 340 may exchange information between the online system 250 and one or more vendor systems 240. The web server 340 serves web pages, as well as other content, such as JAVA®, FLASH®, XML and so forth. The web server 340 may receive and route messages between the online system 250 and a client device 210, for example, instant messages, queued messages (e.g., email), text messages, short message service (SMS) messages, or messages sent using any other suitable messaging technique. A user may send a request to the web server 340 to upload information (e.g., images or videos) that are stored in the content store 210. Additionally, the web server 340 may provide application programming interface (API) functionality to send data directly to native client device operating systems, such as IOS®, ANDROID™, or BlackberryOS.

Authenticating Client Device Execution of an Application Associated with an Online System

FIG. 4 is an interaction diagram of one embodiment of a method for an online system 250 to provide authentication information to a client device 210 for accessing content provided by the online system 250. In other embodiments, the method may include different and/or additional steps than those described in conjunction with FIG. 4. Additionally, in other embodiments, steps of the method may be performed in orders different than the order described in conjunction with FIG. 4.

An online system 250 provides an application associated with the online system 250 to various client devices 210, allowing users of the client devices 210 to access information maintained by the online system 250, to modify information maintained by the online system 250, or to store information using the online system 250. However, the online system 250 regulates execution of the application to client devices 210 associated with users for whom the online system 250 maintains user profiles. This allows the online system 250 to limit access to the online system 250 via the application. To regulate execution of the application, the online system 250 maintains 405 information identifying client devices 210 authorized to execute the application. For example, the online system 250 includes information identifying a client device 210 associated with a user in a user profile maintained by the online system 250 for the user. As another example, the online system 250 stores a table associating a user profile identifier with information identifying a client device 210 associated with a user profile corresponding to the user profile identifier. The online system 250 may maintain 405 any suitable information identifying client devices 210 authorized to execute the application. For example, the online system 250 maintains 405 phone numbers of client devices 210 authorized to execute the application. In another example, the online system 250 maintains 405 device identifiers (e.g., unique device ID numbers, international mobile station equipment identity numbers, equipment serial numbers, mobile equipment identifiers, mobile serial numbers, etc.) of client devices 210 authorized to execute the application.

When a client device 210 that has installed the application associated with the online system 250 launches 410 the application, the client device 210 transmits 415 information identifying the client device 210 to the online system 250. For example, the application obtains a phone number of the client device 210 and transmits 415 the phone number to the online system 250 when the application is launched 410 (i.e., when the application is executed on the client device 210) on the client device 210. As another example, when the application is launched 410 on the client device 210, the application obtains a device identifier stored by the client device 210 and transmits 415 the device identifier to the online system 250. In some embodiments, the client device 210 transmits 415 the information identifying the client device 210 when the application is launched 410 and when the application is subsequently launched 410 after a greater than a threshold amount of time lapses. For example, the client device 210 transmits 415 the information identifying the client device 210 if the application is subsequently launched 410 twenty-four hours after the application was previously launched 410.

The online system 250 compares 420 the information identifying the client device 210 received from the client device 210 with maintained information identifying client devices 210 authorized to execute the application. For example, the online system 250 compares 420 a phone number identifying the client device 210 to phone numbers included in user profiles maintained by the online system 250. As another example, the online system 250 compares 420 a device identifier received from the client device 210 identifying the client device 210 to a table including device identifiers of client devices 210 authorized to execute the application.

Based on the comparison, the online system 250 determines 425 whether the client device 210 is authorized to execute the application. If the received information identifying the client device 210 does not match information maintained 405 by the online system 250 identifying client devices 210 authorized by the online system 250 to execute the application, the online system 250 determines 425 the client device 210 is not authorized to execute the application. In response to determining 425 the client device 210 is not authorized to execute the application, the online system 250 transmits a message to the client device 210 preventing execution of the application in some embodiments. The message may include content for presentation by the client device 210 indicating the client device 210 is not authorized to execute the application.

However, if the comparison indicates that information identifying the client device 210 matches information maintained 405 by the online system 250 identifying client devices 210 authorized to execute the application, the online system 250 determines 425 the client device 210 is authorized to execute the application. For example, if a phone number identifying the client device 210 matches a phone number included in a list of phone numbers authorized to execute the application maintained 405 by the online system 250, the online system 250 determines 250 the client device 210 is authorized to execute the client device 210. In response to determining 425 the client device 210 is authorized to execute the application, the online system 250 obtains 430 authentication information for the client device 210 to execute the application. The online system 250 generates the authentication information in response to determining 425 the client device 210 is authorized to execute the application in some embodiments. For example, the online system 250 generates a password comprising an alphanumeric string satisfying one or more criteria if the online system 250 determines the client device 215 is authorized to execute the application. Example criteria specify a minimum number of characters in the alphanumeric string, specify types of characters (e.g., letters, numbers, symbols) included in the alphanumeric string, and specify a threshold number of different types of characters included in the alphanumeric string. Alternatively, the online system 250 retrieves stored authentication information associated with the information identifying the client device 210 if the client device 210 is determined 425 to be authorized to execute the application.

In some embodiments, the authentication information specifies actions the user associated with the client device 210 is authorized to perform via the application. For example, after determining the client device 210 is authorized to execute the application, the online system 250 identifies a user profile associated with the client device 210 and determines actions that a user corresponding to the user profile is authorized to perform via the application. The online system 250 may authorize different users to perform different actions via the application based on one or more characteristics of user profiles corresponding to the different users. For example, the online system 250 determines a set of actions that a user is authorized to perform via the application based on an employer and a job title included in a user profile maintained by the online system 250 for the user. For example, authentication information obtained 430 for a user having a particular job title and associated with a client device 210 authorized to execute the application allows the user to both access and to modify certain information maintained by the online system 250 via the application; conversely, authentication information obtained 430 for an additional user having an alternative job title and associated with a client device 210 authorized to execute the application allows the user to access the certain information via the application, while preventing the additional user from modifying the certain information. In other embodiments, the online system 250 determines actions that a user is authorized to perform via the application based on suitable characteristic included in a user profile maintained by the online system 250 for the user. Specifying actions that a user is authorized to perform via the application in the authentication information allows the online system 250 to customize functionality of the application for different users of the online system 250. For example, if the online system 250 is associated with an organization, the online system 250 customizes applications associated with the online system 250 executing on client devices 210 associated with different users to provide different functionality to users having different roles within the organization, simplifying creation and implementation of the application.

The online system 250 transmits 435 the authentication information to the client device 210. In various embodiments, the online system 250 transmits 435 the authentication information using a different communication channel than a communication channel from which the online system 250 received the information identifying the client device 210 from the client device 210. For example, the online system 250 received information identifying the client device 210 via an Internet Protocol (IP) network and transmits 435 the authentication information via a cellular network. In some embodiments, the online system 250 transmits 435 a text message including the authentication information to the client device 210.

When the client device 210 receives the authentication information from the online system 250, the authentication information is provided 440 to the application via the client device 210. For example, the client device 210 presents the authentication information to a user, who enters the authentication information into the application. As another example, the application associated with the online system 250 receives the authentication information from the online system 250. When the authentication information is provided 440 to the application, the client device 210 executes 445 the application, allowing a user of the client device 210 to access content maintained by the online system 250 via the application.

In some embodiments, the client device 210 locally stores authentication information received from the online system 250. Subsequently, if the client device 210 is unable to communicate with the online system 250 when the application associated with the online system is launched 410, the application requests the user of the client device 210 provide 440 the previously received authentication information to the application. The application compares the authentication information provided by the user to the authentication information received from the online system 250, and the client device 210 executes 445 the application if the authentication information provided by the user matches the locally stored authentication information received from the online system 250. This allows the client device 210 to execute the application when the client device 210 is unable to communicate with the online system 250, while also allowing the application to verify that the client device 210 has been authorized by the online system 250 to execute the application.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining information identifying client devices authorized to execute an application associated with an online system at the online system;
receiving information at the online system identifying a client device from the client device in response to the client device launching the application associated with the online system;
comparing the information identifying the client device to the maintained information;
determining the client device is authorized to execute the application associated with the online system based on the comparison;
obtaining authentication information for the client device to execute the application associated with the online system in response to the determining; and
transmitting the authentication information to the client device.

2. The method of claim 1, wherein the information identifying client devices authorized to execute the application associated with the online system comprise telephone numbers corresponding to the client devices authorized to execute the application.

3. The method of claim 1, wherein transmitting the authentication information to the client device comprises:
transmitting the authentication information to the client device via a different communication channel than a communication channel through which the online system received the information identifying the client device.

4. The method of claim 1, wherein transmitting the authentication information to the client device comprises:
transmitting a text message including the authentication information to the client device.

5. The method of claim 1, wherein the authentication information comprises a password.

6. The method of claim 1, wherein obtaining authentication information for the client device to execute the application associated with the online system in response to the determining comprises:
generating authentication information satisfying one or more criteria by the online system.

7. The method of claim 1, wherein the authentication information specifies actions a user associated with the client device is authorized to perform via the application.

8. The method of claim 7, wherein the actions the user associated with the client device is authorized to perform via the application are determined based on information maintained by the online system for the user associated with the client device.

9. A method comprising:
launching an application associated with an online system on a client device;
transmitting information identifying the client device to the online system;
receiving authentication information for the application from the online system, the online system obtaining the authentication information in response to determining from the information identifying the client device that the client device is authorized to execute the application;
providing the authentication information to the application via the client device; and
executing the application on the client device in response to the providing.

10. The method of claim 9, wherein receiving authentication information for the application from the online system comprises:
receiving the authentication information via a different communication channel than a communication channel used to transmit the information identifying the client device to the online system.

11. The method of claim 9, wherein the information identifying the client device comprises a phone number associated with the client device.

12. The method of claim 9, wherein the information identifying the client device comprises a device identifier associated with the client device.

13. The method of claim 9, wherein the authentication information specifies actions a user associated with the client device is authorized to perform via the application.

14. A computer program product comprising a computer-readable storage medium having instructions encoded thereon that, when executed by a client device, cause the client device to:
maintain information identifying client devices authorized to execute an application associated with an online system at the online system;
receive information at the online system identifying a client device from the client device in response to the client device launching the application associated with the online system;
compare the information identifying the client device to the maintained information;
determine the client device is authorized to execute the application associated with the online system based on the comparison;
obtain authentication information for the client device to execute the application associated with the online system in response to the determining; and
transmit the authentication information to the client device.

15. The computer program product of claim 14, wherein the information identifying client devices authorized to execute the application associated with the online system comprise telephone numbers corresponding to the client devices authorized to execute the application.

16. The computer program product of claim 14, wherein transmit the authentication information to the client device comprises:
transmit the authentication information to the client device via a different communication channel than a communication channel through which the online system received the information identifying the client device.

17. The computer program product of claim 14, wherein transmit the authentication information to the client device comprises:
transmit a text message including the authentication information to the client device.
